(19) United States
(12) Patent Application Publication
(10) Pub. No.: US 2018/0152918 A1
(43) Pub. Date: May 31, 2018

(54) FLEXIBLE WIRELESS DEVICE OPERATION IN THE PRESENCE OF RADAR SIGNALS

(71) Applicant: QUALCOMM Incorporated, San Diego, CA (US)

(72) Inventors: Michael Richard Green, Needham, MA (US); Albert van Zelst, Woerden (NL); Youhan Kim, San Jose, CA (US)

(21) Appl. No.: 15/362,495

(22) Filed: Nov. 28, 2016

(51) Int. Cl. H04W 72/04; G01S 7/02

(52) U.S. Cl. CPC H04W 72/04; G01S 7/021; H04W 72/0453

(57) ABSTRACT

A method and apparatus are disclosed for transmitting, by a wireless device, wireless communication signals in the presence of one or more radar signals. For at least some embodiments, a wireless communication channel may be divided into a plurality of resource units. When a radar signal is detected within one or more of the resource units, wireless transmissions may be suppressed within those resource units. The resource units without radar signals may be used for wireless transmissions. In this manner, an entire wireless channel need not be vacated when a radar signal is detected, thereby preserving at least some communication bandwidth of the wireless communication channel.

### TECHNICAL FIELD

The example embodiments relate generally to wireless communications, and specifically to operating wireless devices in the presence of radar signals.

### BACKGROUND OF RELATED ART

A wireless local area network (WLAN) may be formed by one or more access points (APs) that provide a shared wireless communication medium for use by a number of client devices or stations (STAs). Each AP, which may correspond to a Basic Service Set (BSS), periodically broadcasts beacon frames to enable any STAs within wireless range of the AP to establish and/or maintain a communication link with the WLAN. A number of APs may be connected together to form an extended BSS.

Wireless devices such as APs and STAs may share operating frequencies with radar devices within the 5 GHz frequency band. The portion of the 5 GHz frequency band shared by wireless devices and radar devices may be referred to as a Dynamic Frequency Selection (DFS) frequency band. When a wireless device detects a radar signal in the DFS frequency band, the wireless device may follow DFS protocols and vacate the DFS frequency band, for example, to avoid interfering with the radar signal. However, vacating the DFS frequency band may reduce the available bandwidth of the WLAN. Although a replacement frequency band may be available in some instances, locating the replacement frequency band may take time and may negatively impact the user's experience.

Thus, there is a need to improve the operation of wireless devices in the presence of radar signals, for example, to preserve bandwidth associated with existing WLANs.

### BRIEF DESCRIPTION OF THE DRAWINGS

The example embodiments are illustrated by way of example and are not intended to be limited by the figures of the accompanying drawings. Like numbers reference like elements throughout the drawings and specification.

FIG. 1 shows an example communication system within which example embodiments may be implemented.

FIG. 2 shows a wireless device that is one embodiment of the wireless devices of FIG. 1.

FIG. 3 is an example diagram of a frequency band showing a plurality of resource units.

FIG. 4A is an example time/frequency graph including signals that may be transmitted by a wireless device within a primary frequency band and a secondary frequency band.

FIG. 4B is an another example time/frequency graph including signals that may be transmitted within the primary frequency band and the secondary frequency band.

FIG. 5 depicts a flowchart illustrating an example operation for transmitting data packets within wireless channels that may include at least one radar signal.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Apparatuses and methods are disclosed that may allow a wireless device to transmit wireless communication signals in the presence of one or more radar signals. In one example, a method of transmitting a data packet in the presence of a radar signal is disclosed. The method may include selecting a first wireless channel, identifying a resource unit within the first wireless channel that includes the radar signal, where the first wireless channel is divided into two or more resource units, and transmitting the data packet to a second wireless device via the first wireless channel while suppressing wireless transmissions within the identified resource unit.

In another example, a wireless device is disclosed. The wireless device may include one or more processors and a memory storing instructions that, when executed by the one or more processors cause the wireless device to select a first wireless channel, identify a resource unit within the first wireless channel that includes a radar signal, where the first wireless channel is divided into two or more resource units, and transmit a data packet to a second wireless device via the first wireless channel while suppressing wireless transmissions within the identified resource unit.

In another example, a non-transitory computer-readable storage medium is disclosed. The non-transitory computer-readable storage medium may store one or more programs containing instructions that, when executed by one or more processors of a wireless device, cause the wireless device to select a first wireless channel, identify a resource unit within the first wireless channel that includes a radar signal, where the first wireless channel is divided into two or more resource units, and transmit a data packet to a second wireless device via the first wireless channel while suppressing wireless transmissions within the identified resource unit.

### DETAILED DESCRIPTION

The example implementations are described below in the context of coordinating channel switch operations when a radar signal is detected in a WLAN for simplicity only. It is to be understood that the example implementations are equally applicable in other suitable wireless networks (such as cellular networks, pico networks, femto networks, satellite networks). As used herein, the terms “WLAN” and “Wi-Fi®” may include communications governed by the IEEE 802.11 family of standards, Bluetooth, HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including an AP and a plurality of STAs, the example implementations are equally applicable to other WLAN systems including, for example, WLANs including a plurality of APs, peer-to-peer (or Independent Basic Service Set) systems, Wi-Fi Direct systems, and/or Hotspots. In addition, although described herein in terms of exchanging data packets between wireless devices, the example implementations may be applied to the exchange of any data unit, packet, and/or frame between wireless devices.

In the following description, numerous specific details are set forth such as examples of specific components, circuits, and processes to provide a thorough understanding of the present disclosure. The term “associated STA” refers to a STA with which a given AP is associated (such as there is an established communication channel or link between the STA and the given AP). The term “non-associated STA” refers to a STA with which a given AP is not associated (such as there is not an established communication channel or link between the STA and the given AP, and thus the STA and the given AP may not yet exchange data frames and/or data packets). The term “wireless channel” may refer to a band and/or range of frequencies within which data frames and/or data packets may be exchanged.

Also, in the following description and for purposes of explanation, specific nomenclature is set forth to provide a thorough understanding of the example implementations. However, it will be apparent to one skilled in the art that these specific details may not be required to practice the example implementations. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The example implementations are not to be construed as limited to specific examples described herein but rather to include within their scopes all implementations defined by the appended claims.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory computer-readable storage medium comprising instructions that, when executed, performs one or more of the methods described above. The non-transitory computer-readable storage medium may form part of a computer program product, which may include packaging materials.

The non-transitory computer-readable storage medium may include random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a computer-readable communication medium that carries or communicates code in the form of instructions or data structures and that may be accessed, read, and/or executed by a computer or other processor.

The various illustrative logical blocks, modules, circuits and instructions described in connection with the implementations disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices (such as a combination of a DSP and a microprocessor), a plurality of microprocessors, one or more microprocessors in conjunction with a DSP core, or any other suitable configuration.

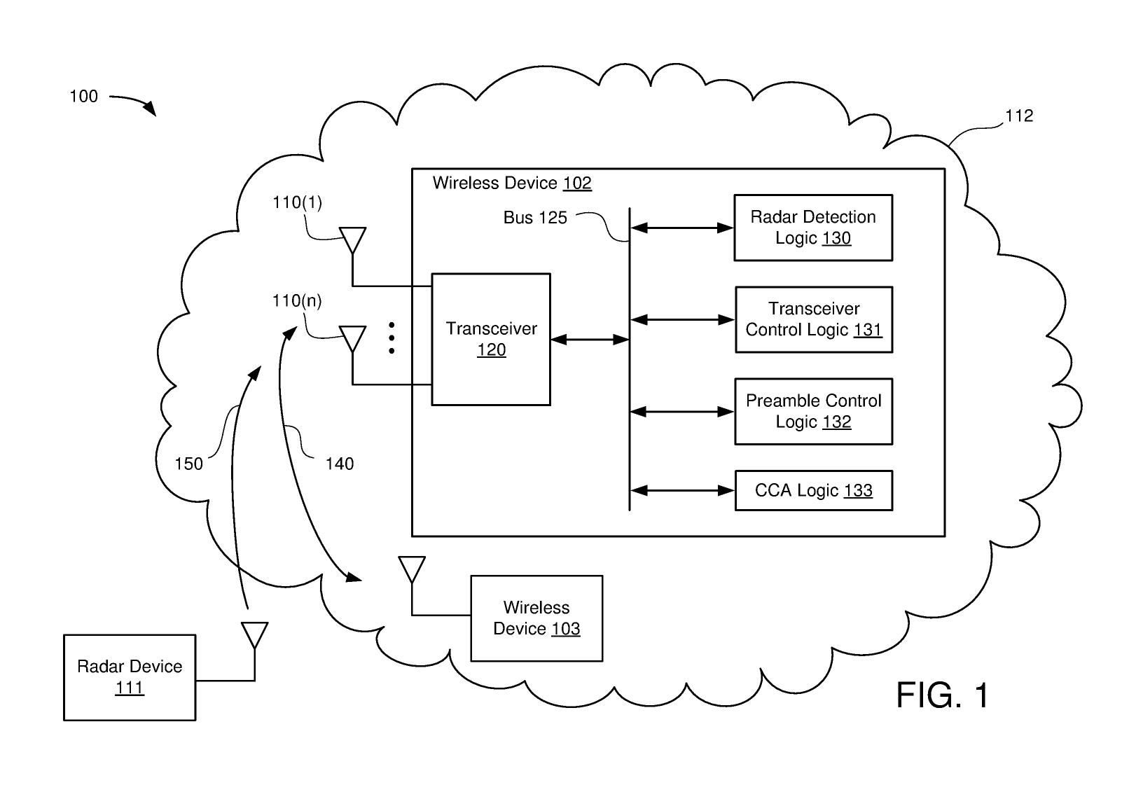

FIG. 1 shows an example communication system 100 within which example embodiments may be implemented. The communication system 100 is shown to include wireless devices 102 and 103 and a radar device 111. Although only two wireless devices 102 and 103 are shown in FIG. 1 for simplicity, it is to be understood that the communication system 100 may include any number of wireless devices. In a similar manner, although only one radar device 111 is shown for simplicity, the communication system 100 may include any number of radar devices.

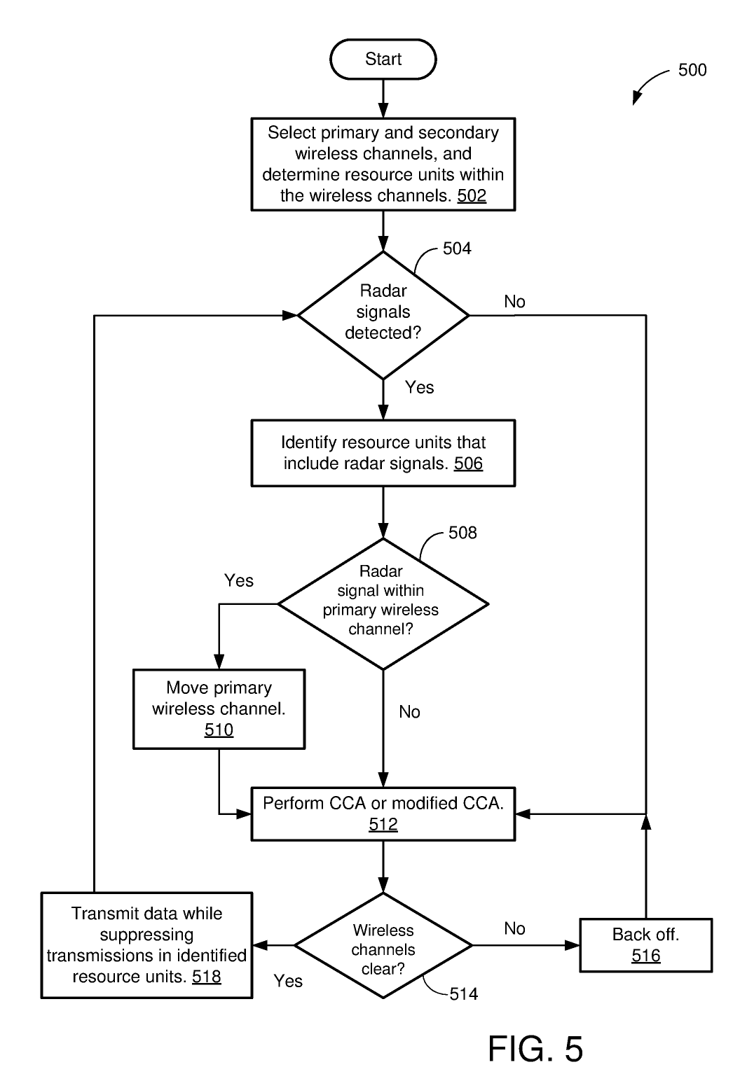

The wireless devices 102 and 103 may be members of, and may communicate through, a wireless local area network (WLAN) 112. For example, the wireless devices 102 and 103 may transmit and receive data packets 140 through the WLAN 112. The wireless devices 102 and 103 may be any suitable Wi-Fi enabled device including, for example, a cell phone, personal digital assistant (PDA), tablet device, laptop computer, gaming console, television, streaming device, or the like. Each of the wireless devices 102 and 103 may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each of the wireless devices 102 and 103 may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 5.

For the wireless devices 102 and 103, the one or more transceivers may include Wi-Fi transceivers, Bluetooth transceivers, cellular transceivers, and/or other suitable radio frequency (RF) transceivers (not shown for simplicity) to transmit and receive wireless communication signals (including data packets). Each transceiver may communicate with other wireless devices within distinct operating frequency bands and/or using distinct communication protocols. For example, the Wi-Fi transceiver may communicate within a 2.4 GHz frequency band and/or within a 5 GHz frequency band in accordance with, for example, IEEE 802.11a/b/g/n/ac/ax specifications. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within wireless devices 102 and 103 may be any technically feasible transceiver such as a ZigBee transceiver described by a specification from the ZigBee Alliance, a WiGig transceiver, and/or a HomePlug transceiver described by a specification from the HomePlug Alliance.

In some embodiments, at least one wireless device within the WLAN 112 may function as an access point (AP). For example, in the communication system 100, either wireless device 102 or wireless device 103 may be configured to operate as the AP. Wireless devices not operating as the AP may be configured to operate as a station (STA). The AP may coordinate and/or control wireless communications within the WLAN 112. For example, the AP may select one or more wireless channels for the transmission and reception of data packets, may transmit periodic beacon frames, and may manage the authentication and association of STAs.

In some aspects, the AP may also divide the selected wireless channels into a plurality of resource units. A resource unit may be a subset of available tones (e.g., sub-carriers) within the selected wireless channels. In some aspects, resource units may be allocated for use with one or more STAs associated with the AP. The use of resource units may permit multiple wireless devices (e.g., STAs) to simultaneously receive data through a single spatial stream and thereby increase throughput (e.g., communication bandwidth) between the multiple wireless devices.

The wireless devices 102 and 103 may operate within a Dynamic Frequency Selection (DFS) frequency band and may follow DFS protocols. For example, the radar device 111 may transmit one or more radar signals 150 that may be received by wireless device 102 (and also by wireless device 103). To preserve the integrity of the radar signals 150, DFS protocols specify that wireless devices 102 and 103 cease operations within frequencies that include the radar signals 150. In some cases, the wireless devices 102 and 103 may simply vacate entire wireless channels that include the radar signals 150. Unfortunately, vacating entire wireless channels may negatively affect the communication bandwidth between the wireless devices 102 and 103. Alternatively, or in addition, the wireless devices 102 and 103 may simply vacate the resource units that include the radar signals 150. Vacating the resource units that include radar signals 150 may preserve at least a portion of the bandwidth between wireless devices 102 and 103 within the selected wireless channels. In addition, the wireless devices affected by the radar signals 150 may not need to search for other wireless channels to replace those vacated, thereby reducing possible operational delays.

Wireless device 102 may include a transceiver 120, a number of antennas 110(1)-110(n), a bus 125, radar detection logic circuits 130, transceiver control logic circuits 131, preamble control logic circuits 132, and clear channel assessment (CCA) logic circuits 133. (Wireless device 103 may also include one or more of these elements described with respect to the wireless device 102, but not illustrated and/or described here for simplicity.) The transceiver 120, which may be coupled to antennas 110(1)-110(n), either directly or through an antenna selection circuit (not shown for simplicity), may be used to transmit signals to and receive signals from other wireless devices. Although not shown in FIG. 1 for simplicity, the transceiver 120 may include any number of transmit chains to process and transmit signals to other wireless devices via antennas 110(1)-110(n), and may include any number of receive chains to process signals received from antennas 110(1)-110(n). Thus, for example implementations, the wireless device 102 may be configured for multiple-input multiple-output (MIMO) operations including, for example, single-user MIMO (SU-MIMO) operations and multi-user MIMO (MU-MIMO) operations.

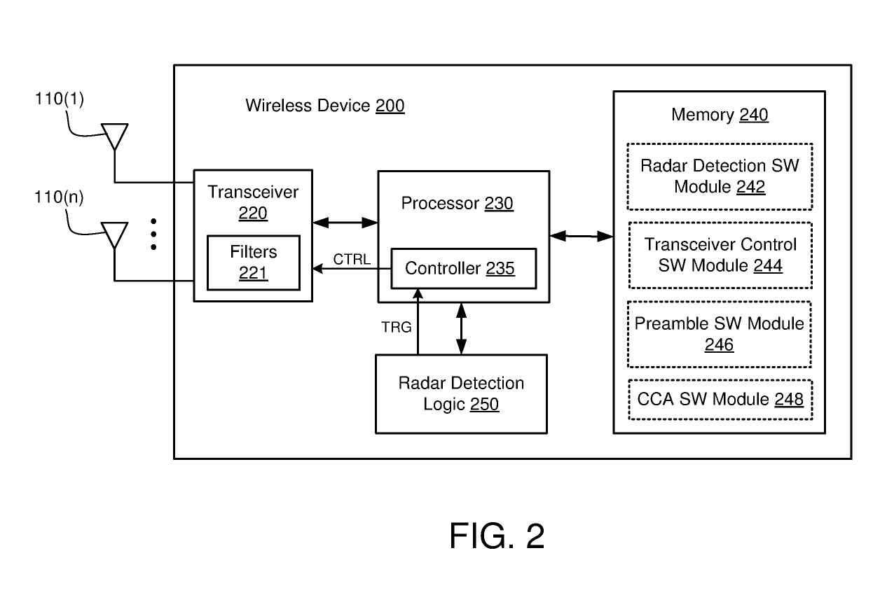

The transceiver 120 may be coupled to the radar detection logic circuits 130, the transceiver control logic circuits 131, the preamble control logic circuits 132, and the CCA logic circuits via the bus 125. The radar detection logic circuits 130 may analyze received signal characteristics provided by the transceiver 120 to detect the presence of radar signals 150 within a wireless channel used by the wireless device 102. In some aspects, the radar detection logic circuits 130 may compare received signal characteristics provided by the transceiver 120 with signal characteristics associated with known radar signals in order to identify the radar signals 150. Operation of the wireless device 102 in the presence of radar signals 150 is described in more detail below in conjunction with FIGS. 2-5.

The transceiver control logic circuits 131 may control wireless communications through the transceiver 120. In some aspects, the transceiver control logic circuits 131 may select and/or change wireless channels used by wireless device 102. For example, if the radar signal 150 is detected in a first wireless channel by radar detection logic circuits 130, then the transceiver control logic circuits 131 may cause the first wireless channel to be vacated, and a second wireless channel to be identified. Selection of the wireless channels may include determining wireless channel bandwidth as well as determining which wireless channels may be selected as the primary and/or secondary channels, for example, to support operation with some legacy wireless devices. Transceiver operation is described in more detail below in conjunction with FIGS. 2 and 5.

The preamble control logic circuits 132 may generate and/or decode the preambles of data packets used for wireless communications by the transceiver 120. In some aspects, the preamble control logic circuits 132 may “zero” tones in a generated preamble of a data packet that may be transmitted in a wireless channel associated with detected radar signals. In other aspects, the preamble control logic circuits 132 may decode the preambles of data packets for wireless channels that may include radar signals. The preamble control logic circuits 132 may cause the transceiver 120 to receive a preamble in a first wireless channel without a radar signal 150, and apply information provided in the received preamble to data packets received in a second wireless channel including a radar signal 150. Preamble reception and generation is described in more detail below in conjunction with FIGS. 2, 4, and 5.

The CCA logic circuits 133 may determine if a selected wireless channel is busy (e.g., has ongoing wireless communication activity) while ignoring any detected activity within one or more resource units associated with radar signals 150. CCA operations are described in more detail below in conjunction with FIGS. 2 and 5.

FIG. 2 shows a wireless device 200 that is one embodiment of the wireless devices 102 and 103 of FIG. 1. The wireless device 200 may include the antennas 110(1)-110(n), a transceiver 220, a processor 230, a memory 240, and radar detection logic 250. The transceiver 220 may be an embodiment of the transceiver 120 of FIG. 1 and may be coupled to antennas 110(1)-110(n) to transmit signals to and receive signals from other wireless devices. Although not shown in FIG. 2 for simplicity, the transceiver 220 may include any number of transmit chains to process and transmit signals to other wireless devices via antennas 110(1)-110(n), and may include any number of receive chains to process signals received from antennas 110(1)-110(n).

Referring also to FIG. 1, the radar detection logic 250 may detect the radar signals 150 having frequency components that fall within frequencies (including resource units) used by wireless device 200, and may generate a trigger signal (TRG) indicating whether radar signals 150 are present. The radar detection logic 250, which is coupled to the processor 230, may include signal processing elements such as Fast Fourier Transform circuits and/or pulse characterization circuits to process signals received from the transceiver 220, and may generate signal characteristics that may be used to identify radar signals 150.

The processor 230, which is also coupled to the transceiver 220 and the memory 240, may be any one or more suitable processors capable of executing scripts or instructions of one or more software programs stored in the wireless device 200 (such as within memory 240). The processor 230 may include or otherwise perform the functions of a controller 235. The controller 235 may be used to control some or all of the wireless transmission and/or reception operations of the transceiver 220. For example, the controller 235 may control transmission operations of transceiver 220 based on the trigger signal TRG. In some aspects, when the trigger signal TRG indicates that radar signals 150 are present, the controller 235 may instruct transceiver 220 to stop transmitting Wi-Fi signals, for example, by asserting a control signal (CTRL). Thereafter, when the trigger signal TRG indicates that radar signals 150 are no longer present (after a minimum non-occupancy period), the controller 235 may instruct transceiver 220 to resume transmitting Wi-Fi signals, for example, by de-asserting the control signal CTRL. In some embodiments, the controller 235 may operate in conjunction with a transceiver control software module 244, described below.

The memory 240 may include a non-transitory computer-readable storage medium (such as one or more nonvolatile memory elements, including, for example, EPROM, EEPROM, Flash memory, a hard drive, etc.) that may store the following software (SW) modules:
a radar detection SW module 242 to detect radar signals received from the transceiver 220;
a transceiver control SW module 244 to control wireless transmission and/or reception operations of the transceiver 220;
a preamble SW module 246 to generate and/or decode preamble packets; and
a CCA SW module 248 to control CCA operations for the wireless device 200.
   Each software module includes program instructions that, when executed by the processor 230, may cause the wireless device 200 to perform the corresponding function(s). Thus, the non-transitory computer-readable storage medium of memory 240 may include instructions for performing all or a portion of the operations of FIG. 5.

Processor 230 may execute the radar detection SW module 242 to analyze received signal characteristics provided by the radar detection logic 250 and/or the transceiver 220 to detect the presence of radar signals 150 within a wireless channel used by the wireless device 200. In some aspects, the radar detection SW module 242 may be executed by the processor 230 to compare the received signal characteristics provided by the radar detection logic 250 with signal characteristics associated with known radar signals in order to identify the radar signals 150. In some aspects, the signal characteristics associated with known radar signals may be stored in a suitable memory (e.g., memory 240) within the wireless device 200. Some example received signal characteristics may include signal pulse width, frequency, periodicity, and/or amplitude. For at least some implementations, the radar detection SW module 242 may be coupled to or perform the functions of a match filter (not shown for simplicity) to match the received signal characteristics with signal characteristics of the known radar signals. In some aspects, processor 230 may execute the radar detection SW module 242 to determine whether radar signals 150 have been detected within one or more resource units of a selected wireless channel.

Processor 230 may execute the transceiver control SW module 244 to control wireless communications through the controller 235 and/or the transceiver 220 directly or indirectly through another device such as the controller 235. In some aspects, the transceiver control SW module 244 may be executed by the processor 230 to select and/or change wireless channels used by wireless device 200. For example, if a radar signal is detected in a first wireless channel by radar detection logic 250 and/or by executing the radar detection SW module 242, then executing the transceiver control SW module 244 may cause the first wireless channel to be vacated, and a second wireless channel to be identified. Selection of the wireless channels may include determining wireless channel bandwidth as well as determining which wireless channels may be selected as the primary and/or secondary channels, for example, to support operation with some legacy wireless devices.

The processor 230 may also execute the transceiver control SW module 244 to divide a selected wireless channel into a plurality of resource units. The resource units may be used to transmit data packets and may also be vacated if radar signal 150 is determined to be within or near the resource units. For example, if a first resource unit includes a radar signal 150, the first resource unit may be vacated (e.g., unused for wireless transmissions) to preserve and/or protect the radar signal 150. In other words, wireless transmissions may be suppressed in resource units with a radar signal 150. In some embodiments, additional resource units (e.g., resource units slightly higher and/or lower in frequency than the first resource unit) may also have wireless transmissions suppressed to provide a guard band to further prevent interference with the radar signal 150.

Processor 230 may execute the preamble SW module 246 to generate and/or decode the preambles of data packets used for wireless communications by the transceiver 220. In some aspects, the processor 230 may execute the preamble SW module 246 to “zero” tones in a generated preamble of a data packet that may be transmitted in a wireless channel associated with detected radar signals. For example, execution of the preamble SW module 246 may cause one or more tones in a preamble that may be associated with one or more radar signals to be set to zero and, therefore, not transmitted. In other aspects, the processor 230 may execute the preamble SW module 246 to decode the preambles of data packets for wireless channels that may include radar signals. For example, the transceiver 220 may be configured to receive data via a first wireless channel and a second wireless channel. A radar signal may be identified within the second wireless channel. Therefore, the preamble transmitted within the second wireless channel may have one or more tones set to zero. Executing the preamble SW module 246 may cause the transceiver 220 to receive a preamble in a first wireless channel without a radar signal 150, and apply information provided in the received preamble to data packets received in a second wireless channel including a radar signal 150. In this manner, the preamble of a data packet may be transmitted on the first wireless channel, and the body of the data packet may be transmitted on the second wireless channel.

Processor 230 may execute the CCA SW module 248 to perform CCA operations within one or more selected wireless channels. In some aspects, processor 230 may execute the CCA SW module 248 to determine if a selected wireless channel is busy (e.g., has ongoing wireless communication activity) while ignoring any detected activity within one or more resource units associated with radar signals 150. In some embodiments, execution of the CCA SW module 248 may configure one or more filters 221 included within the transceiver 220 to suppress frequencies, tones, and/or resource units associated with detected radar signals 150. In other embodiments, execution of the CCA SW module 248 may cause one or more digital processing circuits (not shown for simplicity) within the transceiver 220 to suppress and/or ignore wireless signals at or near frequencies, tones, and/or resource units that may include radar signals 150. CCA operations are described in more detail below in conjunction with FIG. 5.

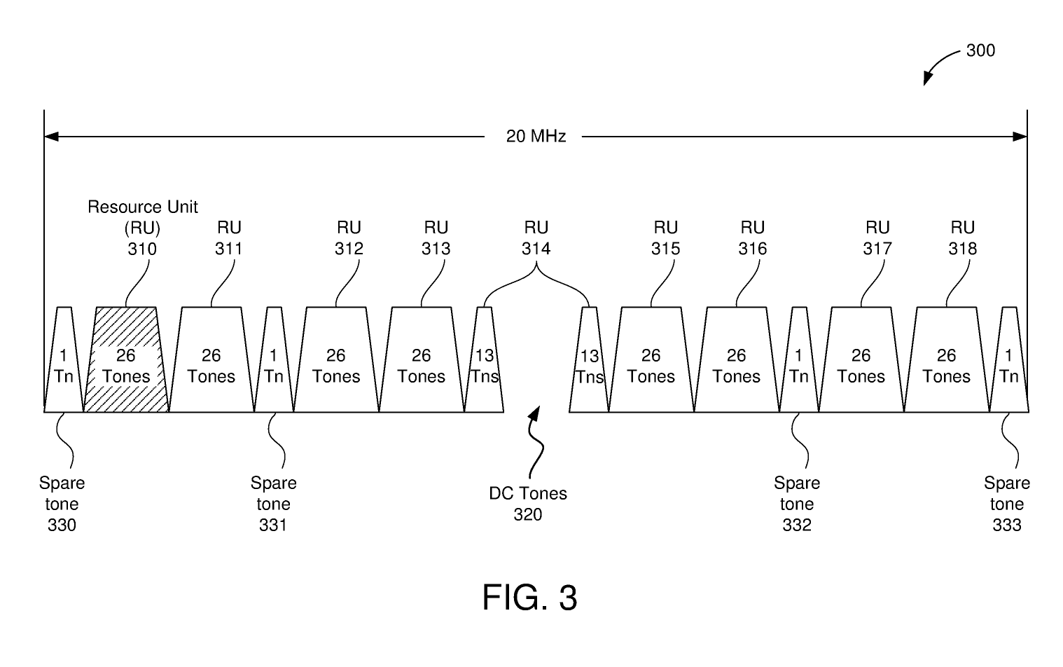

FIG. 3 is an example diagram of a frequency band 300 including a plurality of resource units. In some embodiments, the frequency band 300 may coincide with and/or include one or more wireless channels used for wireless (e.g., Wi-Fi) communications. As shown, frequency band 300 may be 20 MHz wide and may include nine resource units 310-318. In this example, each of the resource units 310-318 may include 26 tones (e.g., sub-carrier frequencies). In other embodiments, the frequency band 300 may be wider than 20 MHz and may include other numbers of resource units having different numbers of tones. For example, the frequency band 300 may be 40 MHz, 80 MHz, 160 MHz, or any technically feasible bandwidth. Furthermore, other resource units may include 52, 106, 245, or any technically feasible number of tones.

Referring also to FIG. 1, an AP may assign some or all of the available resource units 310-318 to one or more of the STAs within the WLAN 112. In some embodiments, the AP may assign each resource unit 310-318 to different users (e.g., distinct STAs associated with the AP) to service nine different users simultaneously. For example, the AP may transmit downlink data to nine different users through the nine distinct resource units 310-318, concurrently. In other embodiments, the available resource units may be assigned to any subset of STAs within the WLAN 112.

The frequency band 300 may also include four spare tones 330-333. In addition, one or more DC tones 320 may also be identified in the frequency band 300. In some aspects, the spare tones 330-333 and the DC tones 320 may not be used to transmit data packets to the STAs. In other embodiments, the frequency band 300 may include different numbers of spare tones and DC tones (not shown for simplicity).

If a resource unit is determined to include a radar signal, then that particular resource unit may be vacated while any remaining resource units may remain in use. For example, if resource unit 310 is determined to include a radar signal 150 (as illustrated with diagonal lines), then the resource unit 310 may be vacated. The AP may continue to use resource units 311-318 to carry the data packets 140 since resource units 311-318 do not contain any radar signals 150.

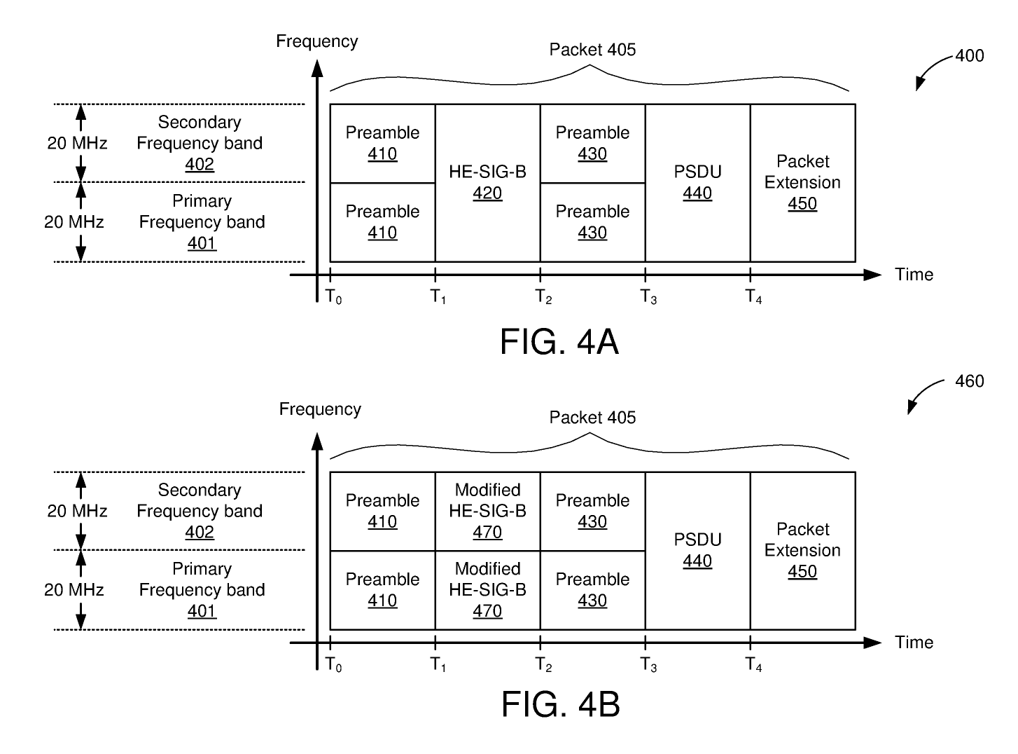

FIG. 4A is an example time/frequency graph 400 showing signals associated with a packet 405 that may be transmitted by a wireless device within a primary frequency band 401 and a secondary frequency band 402. In some embodiments, the primary frequency band 401 may correspond to a first wireless channel, and the secondary frequency band 402 may correspond to a second wireless channel. In this example, the primary frequency band 401 and the secondary frequency band 402 each have a bandwidth of 20 MHz. In other embodiments, the primary frequency band 401 and the secondary frequency band 402 may have other bandwidths. For example, the primary frequency band 401 and/or the secondary frequency band 402 may have a bandwidth of 40, 60, 80, or 160 MHz, not shown for simplicity. In some embodiments, the primary frequency band 401 and the secondary frequency band 402 may coincide with and/or include one or more wireless channels used for wireless (e.g., Wi-Fi) communications. Further, in the time/frequency graph 400, the primary frequency band 401 and the secondary frequency band 402 are shown to be adjacent in frequency. In other embodiments, the primary frequency band 401 and the secondary frequency band 402 may be separated from each other by another frequency band (not shown for simplicity). Also in the time/frequency graph 400, the primary frequency band 401 is shown to be lower in frequency than the secondary frequency band 402. In other embodiments, the secondary frequency band 402 may be lower in frequency than the primary frequency band 401.

At time T₀, a first preamble 410 may be transmitted within the primary frequency band 401 and within the secondary frequency band 402. In some aspects, the preamble 410 may be replicated within the primary frequency band 401 and the secondary frequency band 402. For example, the preamble 410 transmitted within the primary frequency band 401 may be substantially similar to the preamble 410 transmitted within the secondary frequency band 402. The preamble 410 may, for example, provide notice to wireless devices that a High Efficiency Signal B (HE-SIG-B) field 420 is to be transmitted using both the primary frequency band 401 and the secondary frequency band 402. In some aspects, the preamble 410 may also include short and/or long training fields that may be used to align, adjust, and/or calibrate a receiver of a wireless device.

At time T₁, the HE-SIG-B field 420 may be transmitted using both the primary frequency band 401 and the secondary frequency band 402. The HE-SIG-B field 420 may include, for example, information to interpret (e.g., decode) a forthcoming physical-layer service data unit (PSDU) 440. Although not shown in FIG. 4A for simplicity, the PSDU 440 may contain an MPDU that contains payload data. In some aspects, the MPDU, which may also be referred to as a MAC frame, may include a MAC header, a frame body, and a frame check sequence (FCS) field. The MAC header may include a number of fields containing information that describes characteristics or attributes of data encapsulated within the frame body, may include a number of fields indicating source and destination addresses of the data encapsulated within the frame body, and may include a number of fields containing control information. The frame body may store payload data, and the FCS field may store error correction information.

In some aspects, the HE-SIG-B field 420 may include information regarding resource unit allocation and/or usage within selected frequency bands. Although the HE-SIG-B field 420 is depicted in FIG. 4A as separate from the preamble 410, for actual implementations, the HE-SIG-B field 420 may be part of the preamble 410 (e.g., for implementations in which the packet 405 is formatted and/or transmitted in accordance with the IEEE 802.11ax specification).

At time T₂, a second preamble 430 may be transmitted within the primary frequency band 401 and within the secondary frequency band 402. Similar to the preamble 410, the preamble 430 may be replicated in the primary frequency band 401 and the secondary frequency band 402. In some aspects, the preamble 430 may, for example, provide notice to wireless devices that transmission of the PSDU 440 follows.

At time T₃, the PSDU 440 may be transmitted. In this example time/frequency graph 400, the PSDU 440 is transmitted as a 40 MHz signal across the primary frequency band 401 and the secondary frequency band 402. In other embodiments, the PSDU 440 may have different bandwidths based on, for example, the bandwidth of the primary frequency band 401 and the secondary frequency band 402.

At time T₄, a packet extension 450 may be transmitted as a 40 MHz signal across both the primary frequency band 401 and the secondary frequency band 402. The packet extension 450 does not typically store any data. Instead, the packet extension 450 typically stores “dummy” data (e.g., repeating the last symbol of the packet payload), for example, to allow a receiving device more time to decode packet 405 without giving up medium access granted to a transmitting device.

In some embodiments, if a radar signal is detected within the primary frequency band 401, the primary and secondary frequency bands 401 and 402 may be swapped to maintain compatibility with at least some legacy devices (e.g., devices configured to operate in the secondary frequency band 402). For example, if a radar signal is detected within the primary frequency band 401 but not within the secondary frequency band 402, then the secondary frequency band 402 may be re-designated as a new primary frequency band, and the primary frequency band 401 may be re-designated as a new secondary frequency band. The new primary frequency band may enable legacy wireless devices to receive at least some wireless signals and thereby operate within the WLAN 112.

As described above, when a radar signal 150 is detected within a resource unit, then that resource unit may be vacated. However, preambles 410 and 430, as well as the HE-SIG-B field 420, may also need modification so that signals associated with packet 405 are not transmitted in and/or near frequencies that may include the radar signal 150. As shown in FIG. 4A, the HE-SIG-B field 420 may be transmitted across the entire bandwidth of the primary and secondary frequency bands 401 and 402. Thus, information contained in the HE-SIG-B field 420 may be compromised when some of the tones within the HE-SIG-B field 420 associated with the radar signal 150 are suppressed. In some embodiments, the HE-SIG-B field 420 may be modified to accommodate operation of a wireless device in the presence or the radar signal 150 as described below in conjunction with FIG. 4B.

FIG. 4B is an another example time/frequency graph 460 showing signals that may be transmitted within the primary frequency band 401 and the secondary frequency band 402. Similar to the time/frequency graph 400 described above, the preamble 410 may be transmitted at time T₀, the preamble 430 may be transmitted at time T₂, the PSDU 440 may be transmitted at time T₃, and the packet extension 450 may be transmitted at time T₄.

In contrast to time/frequency graph 400, at time T₁, a modified HE-SIG-B field 470 may be transmitted in the primary frequency band 401 and the secondary frequency band 402. In some aspects, information contained in the modified HE-SIG-B field 470 may be duplicated in both the primary frequency band 401 and the secondary frequency band 402. For example, the modified HE-SIG-B field 470 within the primary frequency band 401 may be substantially similar to the modified HE-SIG-B field 470 in the secondary frequency band 402.

If the detection of a radar signal causes one or more resource units of the secondary frequency band 402 to be vacated during transmission of the PSDU 440, then a corresponding frequency component of the modified HE-SIG-B field 470 in the secondary frequency band 402 may also be vacated to comply with DFS protocols. However, since the modified HE-SIG-B field 470 is duplicated in the primary frequency band 401, a wireless device attempting to receive the PSDU 440 within the secondary frequency band 402 may rely on the information contained in the modified HE-SIG-B field 470 in the primary frequency band 401. In a similar fashion, because the preamble 410 and the preamble 430 are repeated in both the primary frequency band 401 and the secondary frequency band 402, the preambles 410 and/or 430 transmitted within the secondary frequency band 402 may have one or more tones suppressed in and around frequencies associated with the radar signal.

FIG. 5 depicts a flowchart illustrating an example operation 500 for transmitting, by a wireless device, data packets within wireless channels that may include at least one radar signal. The example operations described herein are not meant to be exhaustive or limiting, but rather illustrative in nature. Some embodiments may perform the operations described herein with additional operations, fewer operations, operations in a different order, operations in parallel, and/or some operations differently. Moreover, a source operation of an arrow may indicate that the target operation of the arrow is a subset of the source operation. Alternately, the arrow may indicate that the target operation is performed subsequent to the source operation or that the target operation is based on or in response to the source operation. These and other relationships among the operations will be understood by persons of ordinary skill in the art in accordance with the descriptions provided with the flowcharts.

Although the example operation 500 is described below with respect to wireless device 200 of FIG. 2, it is to be understood that the example operation 500 may be performed by any suitable wireless device. Referring also to FIGS. 1-4, the operation 500 begins as primary and secondary wireless channels are selected, and resource units within the primary and secondary wireless channels are determined (502). Primary and secondary wireless channels may be selected and/or assigned by a wireless device (e.g., wireless device 200) operating as an AP. In some embodiments, the primary wireless channel may be a 20 MHz channel to allow at least some legacy wireless devices to interoperate with wireless device 200. Also, in some embodiments, more than one secondary wireless channel may be selected. For example, wireless device 200 may select a 20 MHz primary wireless channel, a 20 MHz secondary wireless channel, and a 40 MHz secondary wireless channel. The wireless device 200 may also determine, allocate, and/or assign resource units within primary and/or secondary wireless channels. For example, the wireless device 200 may determine how many resource units may be included within a primary and/or secondary wireless channel(s), and may also determine how many tones may be included within each resource unit.

Next, the wireless device 200 determines if any radar signals are detected (504). In some aspects, the wireless device 200 may detect the presence of one or more radar signals through radar detection logic 250 and/or by execution of the radar detection SW module 242. If a radar signal is detected, then the wireless device 200 may identify one or more resource units that include the detected radar signals (506). In some aspects, the radar detection logic 250 and/or execution of the radar detection SW module 242 may also identify frequencies associated with the detected radar signal. In some aspects, the wireless device 200 may map detected radar signals to resource units that may be included in the primary and/or secondary wireless channels. In this manner, resource units that include radar signals may be identified.

Next, the wireless device 200 determines if the detected radar signal is included within the primary wireless channel (508). If the detected radar signal is included within the primary wireless channel, then the primary wireless channel may be reassigned to a frequency without any detected radar signals. A primary wireless channel without radar signals may permit legacy wireless devices to maintain communication with the wireless device 200.

If the detected radar signal is within the primary wireless channel (as tested at 508), then the primary wireless channel is moved to a channel without any radar signals (510). Alternative primary wireless channels may be identified by the radar detection logic 250 and/or execution of the radar detection SW module 242. In some embodiments, a primary wireless channel may be swapped with a secondary wireless channel, for example, when the secondary wireless channel does not include any radar signals.

Next, a CCA operation or a modified CCA operation is performed by the wireless device 200 (512). Persons skilled in the art will recognize that a CCA operation may determine whether frequencies and/or wireless channels are busy, and therefore cannot be used for the transmission data packets. In some aspects, the CCA operation may be modified to exclude checking frequencies and/or resource units known to include radar signals and, therefore, not used for the transmission of data packets. As described above with respect to FIGS. 2 and 3, if a resource unit is determined to include a radar signal, then that resource unit may be vacated, and wireless transmissions within the resource unit suppressed. Furthermore, since the vacated resource unit including the radar signal is not used by the wireless device 200, the CCA operation may be modified to ignore (e.g., not check) the vacated resource units. In some embodiments, a configurable filter may be used in conjunction with the CCA operation. For example, the configurable filter (e.g., the filter 221 of FIG. 2) may be adjusted to notch out (ignore) any signals within frequencies and/or resource units associated with radar signals.

Next, if the primary and secondary wireless channels are clear (based on results of the CCA or modified CCA operation checked in 514), then data packets are transmitted within the primary and secondary wireless channels (518). If one or more resource units have been identified as having radar signals, then transmissions of the identified resource units are suppressed. In some aspects as described above with respect to FIG. 4B, tones associated with the identified resource units may be suppressed within one or more preambles transmitted by the wireless device 200. In other aspects, entire preambles having frequencies associated with the identified resource units may be suppressed. Operations then proceed to 504.

If the primary and secondary wireless channels are not clear (as checked in 514), then a back off procedure is performed (516). In some embodiments, the wireless device 200 may wait a variable and/or increasing “back off” time period before returning to 512 to perform another CCA or modified CCA operation.

If the detected radar signal is not within the primary wireless channel (as tested in 508), then operations proceed to 512. Since no radar signals are detected within the primary wireless channel, an alternate primary wireless channel does not need to be identified. Therefore, operations may proceed to 512 to perform CCA or modified CCA operations.

If radar signals are not detected (as tested in 504), then operations proceed to 512. When no radar signals are detected, operations may proceed to 512 to perform CCA operations.

In the foregoing specification, the example embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of transmitting a data packet in the presence of a radar signal by a first wireless device, the method comprising:
selecting a first wireless channel;
identifying a resource unit within the first wireless channel that includes the radar signal, wherein the first wireless channel is divided into two or more resource units; and
transmitting the data packet to a second wireless device via the first wireless channel while suppressing wireless transmissions within the identified resource unit.

2. The method of claim 1, wherein the first wireless channel has a bandwidth of 20 MHz, 40 MHz, 80 MHz, or a combination thereof.

3. The method of claim 1, further comprising:
identifying one or more sub-carriers of the first wireless channel associated with the identified resource unit.

4. The method of claim 3, further comprising:
modifying a preamble of the data packet to suppress the identified sub-carriers.

5. The method of claim 1, further comprising:
selecting a second wireless channel;
designating the first wireless channel as a primary wireless channel;
designating the second wireless channel as a secondary wireless channel; and
suppressing transmission of a preamble of the data packet in the first wireless channel while transmitting the preamble of the data packet in the second wireless channel.

6. The method of claim 5, further comprising:
re-designating the first wireless channel as the secondary wireless channel; and
re-designating the second wireless channel as the primary wireless channel.

7. The method of claim 1, further comprising:
performing a clear channel assessment operation in the first wireless channel except in sub-carriers of the first wireless channel associated with the identified resource unit.

8. The method of claim 7, wherein the clear channel assessment operation includes configuring a filter to suppress the sub-carriers associated with the identified resource unit.

9. The method of claim 1, wherein the first wireless channel includes at least nine resource units, each resource unit including at least 26 sub-carriers.

10. A wireless device comprising:
one or more processors; and
a memory storing instructions that, when executed by the one or more processors, cause the wireless device to:
select a first wireless channel;
identify a resource unit within the first wireless channel that includes a radar signal, wherein the first wireless channel is divided into two or more resource units; and
transmit a data packet to another wireless device via the first wireless channel while suppressing wireless transmissions within the identified resource unit.

11. The wireless device of claim 10, wherein execution of the instructions causes the wireless device to further:
identify one or more sub-carriers of the first wireless channel associated with the identified resource unit.

12. The wireless device of claim 11, wherein execution of the instructions causes the wireless device to further:
modify a preamble of the data packet to suppress the identified sub-carriers.

13. The wireless device of claim 10, wherein execution of the instructions causes the wireless device to further:
select a second wireless channel;
designate the first wireless channel as a primary wireless channel;
designate the second wireless channel as a secondary wireless channel;
suppress transmission of a preamble of the data packet in the first wireless channel; and
transmit the preamble of the data packet in the second wireless channel.

14. The wireless device of claim 13, wherein execution of the instructions causes the wireless device to further:
re-designate the first wireless channel as the secondary wireless channel; and
re-designate the second wireless channel as the primary wireless channel.

15. The wireless device of claim 10, wherein execution of the instructions causes the wireless device to further:
perform a clear channel assessment operation in the first wireless channel except in sub-carriers of the first wireless channel associated with the identified resource unit.

16. The wireless device of claim 15, wherein execution of the instructions to perform the clear channel assessment operation causes the wireless device to further:
configure a filter to suppress the sub-carriers associated with the identified resource unit.

17. A non-transitory computer-readable storage medium storing instructions that, when executed by one or more processors of a wireless device, cause the wireless device to:
select a first wireless channel;
identify a resource unit within the first wireless channel that includes a radar signal, wherein the first wireless channel is divided into two or more resource units; and
transmit a data packet to another wireless device via the first wireless channel while suppressing wireless transmissions within the identified resource unit.

18. The non-transitory computer-readable storage medium of claim 17, wherein execution of the instructions causes the wireless device to further:
identify one or more sub-carriers of the first wireless channel associated with the identified resource unit.

19. The non-transitory computer-readable storage medium of claim 18, wherein execution of the instructions causes the wireless device to further:
modify a preamble of the data packet to suppress the identified one or more sub-carriers.

20. The non-transitory computer-readable storage medium of claim 17, wherein execution of the instructions causes the wireless device to further:
perform a clear channel assessment operation in the first wireless channel except in sub-carriers of the first wireless channel associated with the identified resource unit.
